(19) United States
(12) Patent Application Publication
(10) Pub. No.: US 2020/0184196 A1
(43) Pub. Date: Jun. 11, 2020

(54) VOLUMETRIC SUBSTITUTION OF REAL WORLD OBJECTS

(71) Applicant: X Development LLC, Mountain View, CA (US)

(72) Inventors: Nicholas John Foster, Oakland, CA (US); Matthew Sibigtroth, Richmond, CA (US)

(21) Appl. No.: 16/216,558

(22) Filed: Dec. 11, 2018

(51) Int. Cl. G06K 9/00; G06K 9/62; B25J 9/16; G06T 19/00

(52) U.S. Cl. CPC G06K 9/00214; G06K 9/6215; G06K 9/00671; G06T 19/006; B25J 9/1697

(57) ABSTRACT

Implementations of the present disclosure provide techniques for providing a presentation of the objects that are depicted in an image of a scene, where the presentation improves perceiving the object within the scene. Some implementations include obtaining an image of a scene; identifying an object within the image of the scene; obtaining a particular three-dimensional model that corresponds to the object; generating or updating a three-dimensional representation of the scene based at least on the particular three-dimensional model of the object; and providing at least a portion of the three-dimensional representation of the scene that was generated or updated based on the three-dimensional model of the object to a scene analyzer. The three-dimensional representation of the scene can include data indicating an attribute of the object that is not visible or is not directly derived from the image of the scene.

### BACKGROUND

Machine vision technologies analyze images of a scene to deliver automated inspection, process control, and robot guidance with respect to the scene. The more detailed the input images are, the more accurate analysis of the scene the machine vision technologies can provide.

### SUMMARY

Implementations of the present disclosure include computer-implemented methods for providing detailed images to be used in machine vision technologies. More particularly, implementations of the present disclosure provide 3D representation of objects that are depicted in an image. The 3D representations include 3D features of the respective objects that may not be directly drivable or visible in the image.

In some implementations, the method includes the actions of: obtaining, by one or more sensors of a control system that includes (i) the one or more sensors, (ii) a three-dimensional scene generator, (iii) a database of three-dimensional models, and (iv) a scene analyzer, an image of a scene, identifying an object within the image of the scene, obtaining a particular three-dimensional model that corresponds to the object that was identified within the image of the scene, the particular three-dimensional model being obtained from the database of three-dimensional models, generating or updating, by the three-dimensional scene generator, a three-dimensional representation of the scene based at least on the particular three-dimensional model of the object, and providing, by the control system, the three-dimensional representation of the scene, including at least a portion of the three-dimensional representation of the scene that was generated or updated based on the three-dimensional model of the object, to the scene analyzer.

Other implementations include corresponding systems, apparatus, and computer programs, configured to perform the actions of the methods, encoded on computer storage devices.

These and other implementations may each optionally include one or more of the following features: the three-dimensional representation of the scene includes data regarding a portion of the object that is not visible to the one or more sensors; the three-dimensional representation of the scene includes data indicating an attribute of the object that is not directly derived from the image of the scene; the scene analyzer is a VR engine that is configured to enhance interaction with a virtual representation of the object in the virtual representation of the scene; the scene analyzer is an AR engine that is configured to add information to an annotated representation of the object in the annotated representation of the scene; the scene analyzer is a robot controller that is configured to control a robot relative to the object; the actions further include determining a navigation instruction for the robot based at least on the portion of the three-dimensional representation; the actions further include determining a grasping instruction for the robot based at least on the portion of the three-dimensional representation; wherein the particular three-dimensional model is obtained by: comparing the object that was identified within the image to a plurality of images associated with three-dimensional models in the database, and determining that the object is similar to at least one image associated with the particular three-dimensional model more than being similar to any other image associated with other three-dimensional models in the database.

The present disclosure also provides one or more non-transitory computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

Implementations of the present disclosure provide one or more of the following technical advantages and/or technical improvements over previously available solutions. Images provided as input to a machine vision technology may suffer from the problem of occlusion. For example, self-occlusion, object occlusion, or frame occlusion limit the information that an image of an object provides about the object. Self-occlusion happens when some parts of an object that is captured in an image prevent some other parts of the object to be seen in the image. For example, an image of a front side of a box may provide no information about the back side of the box. Object occlusion happens when some objects in an image cast shadow or obstruct a full view of some other objects in the image. Frame occlusion happens when a part of an object that is captured in an image is out of field of view or beyond of the focus of a camera that has taken the image.

The implementations of the present disclosure provide solutions to the problem of occlusion. To provide more details about a scene captured in an image or about an object depicted in the scene, the implementations provide 3D representations of the objects and/or the scene. The 3D representation of an object is generated based on a 3D model of the object (or a 3D model of a second object that is sufficiently similar to the object). The 3D model includes detailed design features and/or attributes of the object that may be occluded in an image of the object. Accordingly, the implementations provide detailed information about the features of an object that may not be visible in a simple image of the object.

Substituting an image of a scene with a 3D representation of the scene can be significantly beneficial in a variety of technologies such as in the technologies that are related to robotics, process control, automatic inspections, virtual reality (VR), augmented reality (AR), telepresence, scene or object recognition, annotations and visualization, e-commerce and payment applications. For example, the detailed features and designs provided by the 3D representations of objects in a scene can help in navigating a robot relative to the object, guiding the robot to perform a safe gripping or grasping of the objects, protecting the robot from getting in contact with harmful objects (e.g., objects that have high temperature, or high magnetic field), estimating the power and time needed to do a task within the scene, etc. The 3D representations of a scene, as described in this disclosure, can help in generating virtual representations of the scene. Such virtual representation can improve interaction with the scene such as moving through the scene, interacting with the object resided within the scene, etc. The 3D representations can provide more details about the objects that are depicted within an AR field of view and enhance annotation of the objects in an AR representation of the scene. The 3D representations can be used in a variety of technologies such as in telepresence applications by providing a more realistic presentation, in e-commerce and payment applications by providing the ability to transact with 3D objects, etc. In short, the implementations of the present disclosure improve the ability to artificially recognize and analyze a scene from an image of the scene and provide more details about the scene than what would be derived from the image.

Methods in accordance with the present disclosure may include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example application of the implementations of the present disclosure.

FIG. 2 depicts an example system for performing the operations according to the implementations of the present disclosure.

FIG. 3 depicts an example 3D representation of a scene, according to the implementations of the present disclosure.

FIG. 4 depicts an example process that can be executed in accordance with implementations of the present disclosure.

FIG. 5 depicts a schematic diagram of an example computing system for performing the operations according to the implementations of the present disclosure.

Like reference symbols in the various drawings indicate like elements.

### DETAILED DESCRIPTION

Implementations of the present disclosure include computer-implemented methods for providing 3-dimensional (3D) representation of objects that are depicted in an image. The 3D representation provides information that are not directly derivable from the image. For example, a camera may be positioned in a front side of a cup and the image taken by the camera may miss a handle located in a back side of the cup. The present implementations take the image and provides information regarding 3D features of the cup, including the handle on the back side of the cup.

By providing information that are not directly derivable from the image, the implementations reduce the problem of occlusion and provide a more detailed understanding of a scene and the objects within the scene. By doing so, the implementations advance the technologies directed to scene analysis, object detection and 3D object interaction.

Some embodiments of the implementations can be used to enhance augmented reality (AR) and virtual reality (VR) technologies. For example, the implementations can enhance VR scene generation and interactions with virtual objects. By adding details about the objects depicted in a scene, a more accurate virtual scene can be generated and a more prescience interaction with the objects can be achieved. Likewise, the implementations can add details about the objects depicted in a scene is captured within an AR field of view and improve the ability to perceive the object or manipulate or interact with it.

Some embodiments can be used for visual communication applications. For example, by adding details to the objects that are being presented at a video conference, the viewers can get a more realistic understanding of the objects. Such feature can be very useful for introducing or advertising products. In addition, adding details about the objects depicted in a video conference helps the viewer to get a better understanding of the surroundings of a presenter.

Some embodiments can be used in image applications, for example, for scene and/or object recognition, annotation, 3D visualization, etc. For example, the embodiments can be used for 3D visualization of how an object could fit in a scene (e.g., a room). Some embodiments can be used in video applications such as editing or adding visual effects of an image or a video. Some embodiments can be used in e-commerce and payment applications, such as providing the ability to transact with 3D objects.

Some embodiments can be used to analyze a scene and provide information of the 3D features of the scene to a robot controller. The robot controller may use the 3D features to facilitate a movement and/or activities of a robot. In the above example, the 3D features associated with the 3D representation of the cup provide information about the handle on the back of the cup the robot controller. This information may affect the way that the robot grasps or grips the cup.

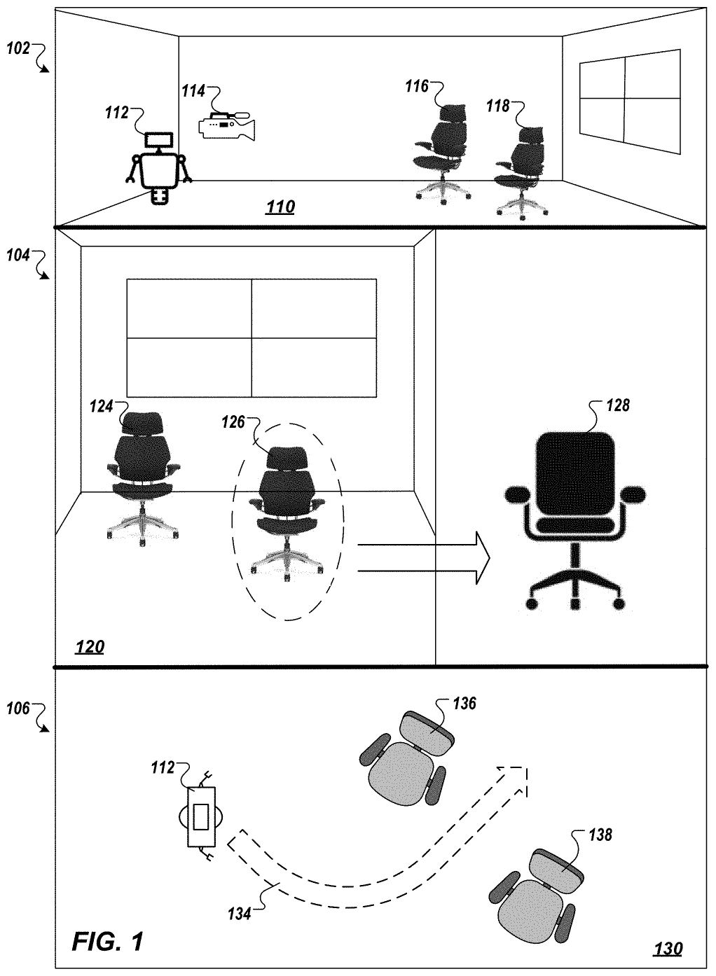

FIG. 1 depicts an example environment for executing the implementations of the present disclosure. Part 102 of FIG. 1 illustrates a room 110 that includes two chairs 116 and 118. Camera 114 takes an image of the room 110. In this example, the image is to be processed to give instructions about the objects in the room to the robot 112 so that the robot 112 can navigate through the room without contacting any of the objects.

Part 104 of FIG. 1 illustrates the 2D image 120 that is taken by the camera 114. The 2D image 120 depicts the chairs 116 and 118 as the objects 124 and 126.

Since the 2D image 120 of the room 110 depicts the chairs 116 and 118 only from one angle, the 2D image 120 has no information about the 3D features of the chairs. For example, the 2D image 120 provides no information about how much space each of the chairs has taken, the thickness of any parts of the chairs, the features located in the back of the chairs such as knobs, handles, etc. Accordingly, the 2D image 120 may not provide enough information for an accurate navigation of the robot 112.

To provide the 3D features of the objects identified in the 2D image, the objects are extracted from the image and compared with a plurality of candidate images that are obtained from a database. For each of the extracted objects, a candidate image that corresponds to the extracted object is selected from among the candidate images. For example, the selected image may be the most similar image to the object extracted from the 2D image as compared to the other candidate images obtained from the database.

Each candidate image is associated with a 3D model. The 3D model has information about identity, characteristics, and/or visual appearance of an object that the model represents. The 3D model associated with the candidate image that is selected as corresponding to the extracted object can provide detailed information about the object. This detailed information is used to generate a three dimensional representation of the object, which can be used as a part of a 3D representation of the scene that is depicted in the 2D image.

For example, in part 104 of FIG. 1, the object 126 is identified and extracted from the 2D image 120. By comparing the 2D image of the object 126 to candidate images obtained from a database, the 3D model 128 is obtained. The 3D model 128 has information such as the size of the object that the model represents. A 3D representation 138 of the object 126 can be generated by using the information associated with the 3D model 128. The 3D representation of the object 126 is used to generate a 3D representation 130 of the room 110, for example, by substituting the 3D representation of the object 126 in a 2D or a 3D representation of the room.

Although the image 120 in this example is a 2D image, the image received from the sensors can be a 3D image. For example, the image may be taken by a depth camera that can provide a 3D image of the scene. In such case, the 3D representation of the scene can update the 3D image by substituting the 3D model into the 3D image and/or by adding the information of the 3D model 128 into the 3D image. The 3D representation can update the 3D image to improve the fidelity (e.g., resolution, details, etc.) of the 3D image. Alternatively or in addition, the 3D representation can be generated in the same manner as described above with respect to a 2D image, and substitute the 3D image that was received from the sensors.

The 3D representation of the scene can be used for a variety of purposes. For example, the 3D representation can be used to enhance a virtual, interactive, and/or annotated representation of the room in VR, AR, telepresence, e-commerce, robotics, or other technologies.

Part 106 of FIG. 1 represents an example application of the 3D representation of the scene in robotic technologies. In this example, the 3D representation 130 of the room 110 is provided to a robot controller. The robot controller uses the information associated with the 3D representation 130 to facilitate the robot's activities. Based on the 3D representation 130, the robot controller designates the navigation path 134 for the robot's movement through the room 110. In another example (not shown), the 3D representation 130 can be used to generate a virtual representation of the room 110 or can be used to annotate the objects resided in the room in a video or image representation of the room 110.

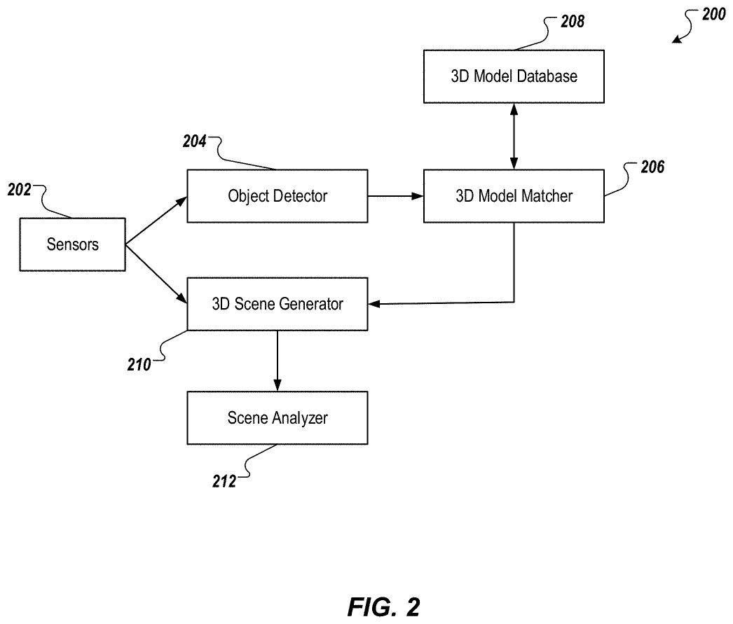

FIG. 2 depicts an example system 200 for performing the operations according to the implementations of the present disclosure. The system 200 can be implemented by a combination of hardware, software and firmware.

The sensors 202 include any device or combination of devices that are capable of taking an image or a video. For example, the sensors can include the camera 114 in FIG. 1. The image can include a 2D image, a colored images, black and while images, infrared images, etc.

The sensors can be positioned in a fixed location. For example, the sensors can be part of a security camera, or a camera that takes a video for video conferencing purposes. The sensors may move around a scene or may be positioned on a movable apparatus. For example, the sensors can be attached to a moving robot or can be wearable as a headset (e.g., as an AR headset or a goggle).

To reduce the power consumption of the sensors or the apparatus that implements the system 200, the sensors may be configured to take periodic or a few shots of images rather than continuous images such as videos. For example, a robot may take one photo for every predetermined period of time. The predetermined period of time can be a fixed period, such as 5 minutes, or can be determined based on the robot's operation speed, such as one photo per minute if operating at a first level speed and two photos per minute if operating at a second speed that is higher than the first speed.

The sensors may take a photo upon detecting a change in the environment, such as a change in light. The sensors may take a new photo upon detecting a movement. For example, in the case of the sensors on a headset, the sensors may take a new photo upon detecting that a user who is wearing the headset has turned his head or has walked. The sensors may take a new photo upon detecting of a movement of an object within the scene. For example, in a video conferencing, the sensors may take a photo upon a detection of a movement of the presenter or an object that is being presented. A movements can be detected by the sensors 202 or by one or more other sensors that are in communication with the sensors 202.

The sensors 202 send the image to an object detector 204 and a 3D scene generator 210. The object detector 204 detects one or more objects in the image. For example, the object detector detects object 126 from the 2D image 120 in FIG. 1. In some implementations, the object detector compares the image with an older image of the scene to detect one or more objects that are newly added to the scene. In some implementations, the object detector detects one or more particular object types. For example, in an image of a warehouse, the object detector may look for only couches and tables and ignore other shapes in the scene. The object detector may use detecting models and rules for such detections.

The object detector sends the object detected in the image to a 3D model matcher 206. The 3D model matcher compares the object with a plurality of candidate images associated with different objects to find and select a candidate image that corresponds to the object identified in the image. The 3D model matcher 206 may select a candidate image that is the most similar image to the object defined in the image as compared to any other candidate image. The 3D model matcher 206 may select a candidate image based on one or more features of the object depicted in the image. For example, the image of the object may depict one or more of a label, a bar code, a particular shape, etc. that can be used to identify the object and/or one or more candidate images associated with the object. For example, the 3D model matcher may associate a particular bottle shape to a particular type of beverage.

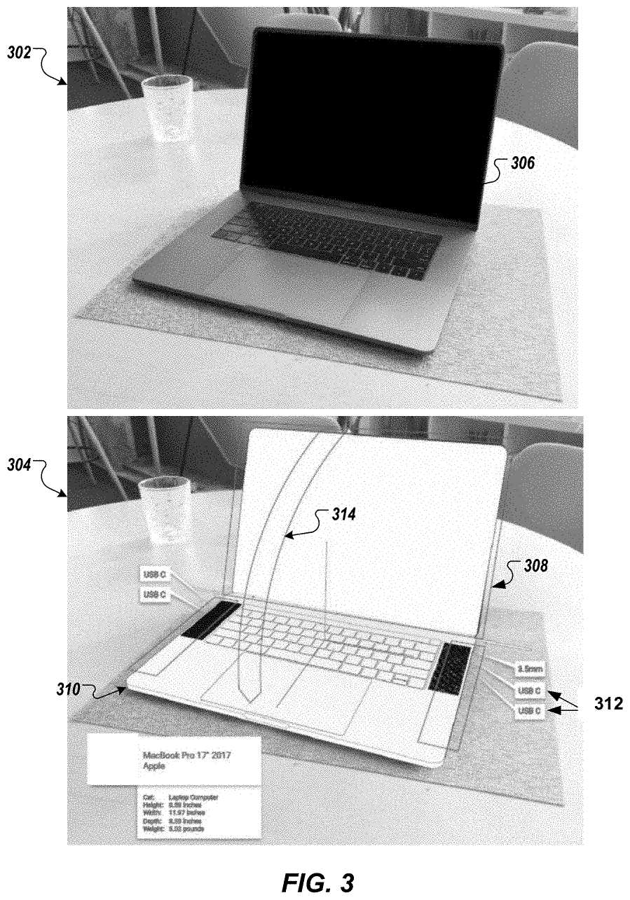

The 3D model matcher 206 communicates with the 3D model database 208 to obtain a particular 3D model associated with the selected candidate image. The 3D models can include computer aided design (CAD) model of one or more objects. For example, FIG. 3 illustrates a CAD model 308 of the object 306 identified in the 2D image 302. The 3D models may have been obtained from the designers or manufacturers of different objects and stored at the 3D model database 208.

A 3D model may be associated with multiple candidate images. In some implementations, the candidate images associated with a 3D model are generated based on the 3D models. For example, a plurality of candidate images associated with a CAD model can be artificially generated from the CAD model.

In some implementations, a plurality of candidate images associated with a 3D model are generated independently from the 3D model. For example, the candidate images can include 2D images that were taken from different angles of an object that is represented by the 3D model. The candidate images can be stored in the 3D model database 208, or in another database in communication with the 3D model database 208 and/or in communication with the 3D model matcher 206.

Each candidate image may represent an angular view of the object that is represented by the 3D model. In searching for a candidate image that is substantially similar to the object identified in the image taken by the sensors 202, the 3D model matcher 206 may search multiple candidate images that represent different angular views of an object represented by a 3D model. If the 3D model matcher 206 finds a candidate image that presents an object's angular view that is substantially similar to the orientation of the object in the image from the sensors, the 3D model matcher selects the candidate image as corresponding to the object in the image from the sensors. The 3D model matcher obtains the 3D model that corresponds to the selected candidate image from the 3D model database 208.

A 3D model can provide general or detailed information about an object that the model represents. The 3D model can provide an identity (e.g., a chair, a laptop, a cup, etc.) and/or one or more features of the object. The 3D model can also provide information about the orientation from which the selected image was taken.

Each 3D model in the database of 3D models can include one or more features of the object that the model represents. For example, a 3D model can include physical features of the object such as size, weight, mechanical elements, color, material, grasping features, etc. A 3D model can include non-visible features such as temperature, magnetic field, etc. of different parts of the object. A 3D model can include sale-related features of the object such as price, retail stores that sell the object, expected delivery time, etc. These features can provide information that is not directly derived from a 2D image of the object. Such information can be used to enhance recognition of or interaction with the object or a 3D representation of the object (e.g., in a virtual representation of the scene). For example, such information can indicate what components or parts the object has that may be occluded in the 2D image, how much power would be needed to pick up an object, which part of the object are safe to approach in terms of, for example, temperature, magnetic field, etc., how to safely handle the object, etc.

The 3D model matcher 206 sends the obtained 3D model to the 3D scene generator 210. The 3D scene generator uses the information of the 3D model and the image of the scene received from the sensors 202 to generate a 3D representation of the scene. The 3D representation of the scene can be generated by replacing one or more objects that are identified from the scene by the object detector 204, with their respective 3D models and/or with 3D representations of the objects generated from the respective 3D models.

The 3D representation of the scene can include data that was not directly derived from the image of the scene taken by the sensors 202. For example, the 3D representation 130 of the scene 110 includes information about the sizes of the chairs 116 and 118 (which are represented by the 3D representations 136 and 138, respectively) that were not directly derived from the 2D image 120 of the room 110.

The 3D representation of the scene can include information such as design features of the object that is not visible from the image obtained from the sensors 202. For example, the 3D representation 310 of the object 306 in FIG. 3 has information about the USB ports 312, which were not visible from the angle the 2D image 302 was taken.

The 3D representation of the scene can include data indicating an attribute of the object that is not discernable from the image obtained from the sensors 202. For example, the 3D representation of the scene may indicate temperature of different objects in the scene, particular parts of an object that need to be handled with care, particular elements of an object that are designed for functional purposes such as grasping, areas with high magnetic field that a robot should avoid, etc.

For example, the 3D representation 304 in FIG. 3 may indicate that the object 306 that is represented by the 3D representation 308 should not be gripped by the top portion of the object (i.e., the display portion). As another example, the 3D representation 304 includes data indicating that the object associated with the 3D model 308 can be folded along the direction 314 for easier and safer carriage of the object.

As another example, a cup that is made of crystal may need to be handled differently from a cup that is made of glass or a cup that is made of plastic. An image of a cup may not provide enough information to distinguish the material of the cup. For example if the same power that is used for grasping a glass cup is used for grasping a crystal cup or a plastic cup, the crystal cup may slip and fall while the plastic cup may crush and crumple. The 3D representation of the cup can provide information about the material of the cup to allow a more accurate calculation of the resources needed for handling the cup.

The 3D representation of the scene can be used for a variety of purposes. For example, the 3D scene generator may send at least a portion of the 3D representation of the scene to a scene analyzer 212 to analyze the scene. The scene analyzer can use the 3D representation of the scene to enhance a virtual, interactive, and/or annotated representation of the room in VR, AR, telepresence, e-commerce, robotics, etc. technologies.

For example, the scene analyzer can be a robot controller for use in controlling a robot relative to the objects in the scene. The robot controller uses the received portion of the 3D representation of the scene to determine instructions that control movements and/or activities of a robot. The instructions can include navigation instructions that guide the robot's movement relative to the objects in the scene. The instructions can include grasping instructions that provide information such as which parts of the objects in the scene are safe to handle, how much power may be needed to move an object, etc.

The scene analyzer can be an AR engine or a VR engine. The AR engine may use the 3D representation to analyze a part of the scene that is depicted in an AR field of view and/or add details about the objects (e.g., the object 138) depicted in the scene. The VR engine may use the 3D representation to generate a virtual representation of the scene. Information from the 3D representation can be used to enhance accuracy in perceiving the objects or interacting with a virtual representation of the objects.

The scene analyzer may use the information of the 3D representation to determine what objects are included within the scene, what objects are missing, and/or what other objects can be added to the scene. For example, the scene analyzer may determine that the scene is a truck trunk that contains five chairs and has room for three more chairs. The scene analyzer can also determine which chair types can fit in the trunk.

As another example, the scene analyzer may determine that the scene depicts a part of a machinery that misses a part. For example, an ideal version of the machinery may include four screws while the 3D representation shows only three screws on the machinery. This information can be used, for example, to detect the defects in the machinery. The scene analyzer may determine different modes of an object. For example, a machinery may have a locked and an unlocked mode and the 3D representation may determine that the machinery depicted in an image is currently in the locked mode.

The scene analyzer may be used for visual communication purposes. For example, the 3D representation can be used in a video conferencing presentation to give the viewers a better understanding of the surroundings of the presenter. The 3D representation can provide non-discernable details about a product or an object that is being introduced in a video conference. Such details can provide the viewers a better understanding of the object.

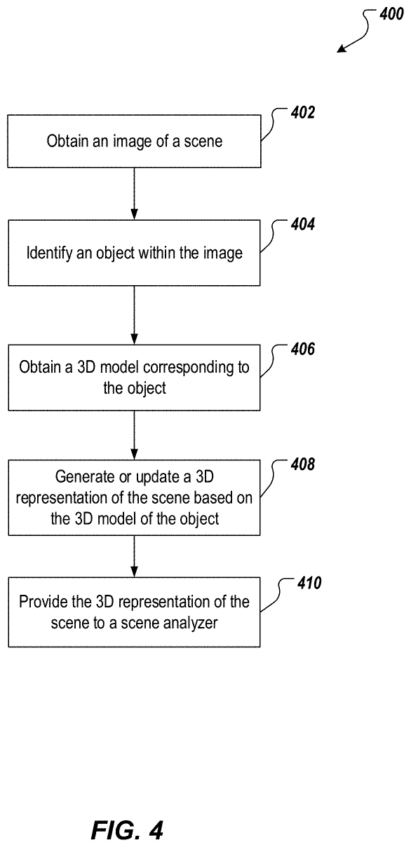

FIG. 4 depicts an example process 400 that can be executed in accordance with the implementations of the present disclosure. In some implementations, the example process 400 may be performed using one or more computer-executable programs executed using one or more computing devices. The process 400 can be performed by the system 200 depicted in FIG. 2.

An image of a scene is obtained (402). The image can be obtained from the sensors 202 that have taken the image. For example, the 2D image 120 of a scene of the room 110 in FIG. 1 is obtained from the camera 114 that takes the 2D image.

An object within the image is identified (404). The object can be identified by any proper image processing techniques known to a person of ordinary skill in this art. For example, the object detector 204 can use image processing techniques to identify and/or extract the object 126 from the 2D image 120.

A 3D model corresponding to the object is obtained (406). For example, the 3D model matcher 206 can compares the object identified in the image with a plurality of candidate images to find a particular candidate image that is sufficiently similar to the object in the image that was obtained at 402. The 3D matcher communicates with the 3D model database 208 to obtain the 3D model that is associated with the particular candidate image. The 3D model may include information that are not discernable from the image of the scene that was obtained at 402.

The obtained 3D model is used to generate or update a 3D representation of the scene (408). The 3D representation of the scene can be generated or updated by substituting the object in the image or in a 3D representation of the scene, with the 3D model. The 3D representation of the scene can add the information associated with the 3D model to the object identified at 404. Part 106 of FIG. 1 illustrates a 3D representation 130 of the scene depicted in the 2D image 120. The 3D representation 130 was generated based on the 3D model 128 associated with the object 126. The 3D representation of the scene can include information about the objects in the scene that were not apparent from the image that was obtained at 402. In case that the image is a 3D image, the 3D image can be considered as a 3D representation that is being updated at 408. The updated representation can provide a higher fidelity, resolution, details, etc. that than the 3D image. Similarly, in case that the image is already associated with a first 3D representation, the first 3D representation can be updated at 408 based on the 3D model obtained at 406, to provide an updated 3D representation of the scene.

The 3D representation of the scene, including at least a portion of the 3D representation of the scene that was generated or updated based on the 3D model of the object, is provided to a scene analyzer (410). The scene analyzer uses the information in the 3D representation to analyze the scene and/or the object. The scene analyzer may use the information that were not directly derived from the image to provide more details about the object, such as indicating how to interact with the object. The scene analyzer can use the 3D representation of the scene to enhance a virtual, interactive, and/or annotated representation of the room in VR, AR, telepresence, e-commerce, robotics, etc. technologies.

For example, the scene analyzer can be a robot controller that uses the 3D representation for controlling one or more robots relative to the object identified at 404. For example, a robot controller can use the 3D representation 130 of the scene to provide navigation instructions to the robot 112 with respect to the object 138. The scene analyzer can be a VR or an AR engine that uses the 3D representation to enhance interaction with a virtual representation of the object. The scene analyzer can be part of a video communication application that uses the 3D representation to provide a more realistic presentation of the content presented during a video conference.

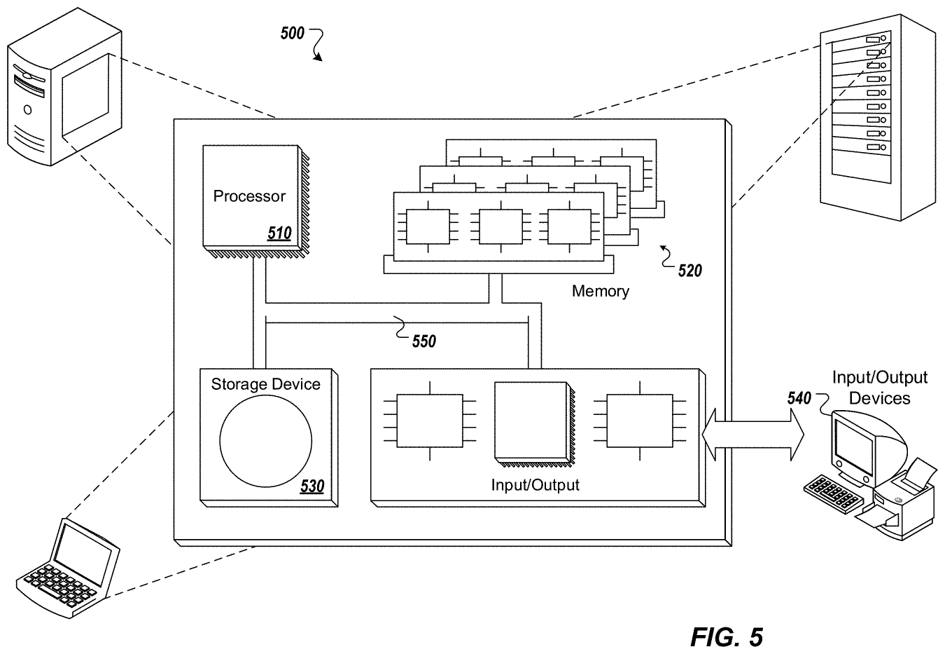

FIG. 5 depicts a schematic diagram of an example computing system 500 to execute the implementations of the present disclosure. The system 500 may be used to perform the operations described with regard to one or more implementations of the present disclosure. For example, the system 500 may be included in any or all of the server components, or other computing device(s), discussed herein. The system 500 may include one or more processors 510, one or more memories 520, one or more storage devices 530, and one or more input/output (I/O) devices 540. The components 510, 520, 530, 540 may be interconnected using a system bus 550.

The processor 510 may be configured to execute instructions within the system 500. The processor 510 may include a single-threaded processor or a multi-threaded processor. The processor 510 may be configured to execute or otherwise process instructions stored in one or both of the memory 520 or the storage device 530. Execution of the instruction(s) may cause graphical information to be displayed or otherwise presented via a user interface on the I/O device 540.

The memory 520 may store information within the system 500. In some implementations, the memory 520 is a computer-readable medium. In some implementations, the memory 520 may include one or more volatile memory units. In some implementations, the memory 520 may include one or more non-volatile memory units.

The storage device 530 may be configured to provide mass storage for the system 500. In some implementations, the storage device 530 is a computer-readable medium. The storage device 530 may include a floppy disk device, a hard disk device, an optical disk device, a tape device, or other type of storage device. The I/O device 540 may provide I/O operations for the system 500. In some implementations, the I/O device 540 may include a keyboard, a pointing device, or other devices for data input. In some implementations, the I/O device 540 may include output devices such as a display unit for displaying graphical user interfaces or other types of user interfaces.

The features described may be implemented in digital electronic circuitry, or in computer hardware, firmware, software, or in combinations of them. The apparatus may be implemented in a computer program product tangibly embodied in an information carrier (e.g., in a machine-readable storage device) for execution by a programmable processor; and method steps may be performed by a programmable processor executing a program of instructions to perform functions of the described implementations by operating on input data and generating output. The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, application-specific integrated circuits (ASICs).

To provide for interaction with a user, the features may be implemented on a computer having a display device such as a cathode ray tube (CRT) or liquid crystal display (LCD) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a local area network (LAN), a wide area network (WAN), and the computers and networks forming the Internet.

The computer system may include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method comprising:
obtaining, by one or more sensors of a control system that includes (i) the one or more sensors, (ii) a three-dimensional scene generator, (iii) a database of three-dimensional models, and (iv) a scene analyzer, an image of a scene;
identifying, by the control system, an object within the image of the scene;
obtaining, by the control system, a particular three-dimensional model that corresponds to the object that was identified within the image of the scene, the particular three-dimensional model being obtained from the database of three-dimensional models;
generating or updating, by the three-dimensional scene generator, a three-dimensional representation of the scene based at least on the particular three-dimensional model of the object; and
providing, by the control system, the three-dimensional representation of the scene, including at least a portion of the three-dimensional representation of the scene that was generated or updated based on the three-dimensional model of the object, to the scene analyzer.

2. The method of claim 1, wherein the three-dimensional representation of the scene includes data regarding a portion of the object that is not visible to the one or more sensors.

3. The method of claim 1, wherein the three-dimensional representation of the scene includes data indicating an attribute of the object that is not directly derived from the image of the scene.

4. The method of claim 1, wherein the scene analyzer is a VR engine that is configured to enhance interaction with a virtual representation of the object in a virtual representation of the scene.

5. The method of claim 1, wherein the scene analyzer is an AR engine that is configured to add information to an annotated representation of the object in an annotated representation of the scene.

6. The method of claim 1, wherein the scene analyzer is a robot controller that is configured to control a robot relative to the object.

7. The method of claim 6, further comprising determining, by the robot control, a navigation instruction for the robot based at least on the portion of the three-dimensional representation.

8. The method of claim 6, further comprising determining, by the robot control, a grasping instruction for the robot based at least on the portion of the three-dimensional representation.

9. The method of claim 1, wherein the particular three-dimensional model is obtained by:
comparing the object that was identified within the image to a plurality of images associated with three-dimensional models in the database; and
determining that the object is similar to at least one image associated with the particular three-dimensional model more than being similar to any other image associated with other three-dimensional models in the database.

10. A non-transitory computer-readable storage medium coupled to one or more processors and having instructions stored thereon which, when executed by the one or more processors, cause the one or more processors to perform operations, the operations comprising:
obtaining by one or more sensors an image of a scene;
identifying an object within the image of the scene;
obtaining a particular three-dimensional model that corresponds to the object that was identified within the image of the scene, the particular three-dimensional model being obtained from a database of three-dimensional models;
generating or updating a three-dimensional representation of the scene based at least on the particular three-dimensional model of the object; and
providing at least a portion of the three-dimensional representation of the scene, including at least a portion of the three-dimensional representation of the scene that was generated or updated based on the three-dimensional model of the object, to a scene analyzer.

11. The non-transitory computer-readable storage medium of claim 10, wherein the three-dimensional representation of the scene includes data regarding a portion of the object that is not visible to the one or more sensors.

12. The non-transitory computer-readable storage medium of claim 10, wherein the three-dimensional representation of the scene includes data indicating an attribute of the object that is not discernable from the image of the scene.

13. The non-transitory computer-readable storage medium of claim 10, wherein the scene analyzer is a VR engine that is configured to enhance interaction with a virtual representation of the object in a virtual representation of the scene.

14. The non-transitory computer-readable storage medium of claim 10, wherein the scene analyzer is an AR engine that is configured to add information to an annotated representation of the object in an annotated representation of the scene.

15. The non-transitory computer-readable storage medium of claim 10, wherein the scene analyzer is a robot controller that is configured to control a robot relative to the object.

16. A system, comprising:
a computing device; and
a computer-readable storage device coupled to the computing device and having instructions stored thereon which, when executed by the computing device, cause the computing device to perform operations, the operations comprising:
obtaining by one or more sensors an image of a scene;
identifying an object within the image of the scene;
obtaining a particular three-dimensional model that corresponds to the object that was identified within the image of the scene, the particular three-dimensional model being obtained from a database of three-dimensional models;
generating or updating a three-dimensional representation of the scene based at least on the particular three-dimensional model of the object; and
providing at least a portion of the three-dimensional representation of the scene, including at least a portion of the three-dimensional representation of the scene that was generated or updated based on the three-dimensional model of the object, to a scene analyzer.

17. The system of claim 16, wherein the three-dimensional representation of the scene includes data regarding a portion of the object that is not visible to the one or more sensors.

18. The system of claim 16, wherein the scene analyzer is a VR engine that is configured to enhance interaction with a virtual representation of the object in a virtual representation of the scene.

19. The system of claim 16, wherein the scene analyzer is an AR engine that is configured to add information to an annotated representation of the object in an annotated representation of the scene.

20. The system of claim 16, wherein the scene analyzer a robot controller is configured to control a robot relative to the object.
